(19) United States
(12) Patent Application Publication
(10) Pub. No.: US 2019/0015880 A1
(43) Pub. Date: Jan. 17, 2019

(54) Processes for Treating Acid Producing Waste Rock

(71) Applicant: Global Aquatica Pty Ltd, Adelaide (AU)

(72) Inventor: Samuel Patrick Costin, Adelaide (AU)

(21) Appl. No.: 16/069,596

(22) PCT Filed: Jan. 13, 2017
(86) PCT No.: PCT/AU2017/000005

§ 371 Date: Jul. 12, 2018

(30) Foreign Application Priority Data
Jan. 15, 2016 (AU) 2016900129

(51) Int. Cl. B09C 1/08; B09B 3/00; C02F 1/34; C02F 1/72; C02F 3/34

(52) U.S. Cl. CPC B09C 1/08; B09B 3/0016; C02F 2101/101; C02F 1/72; C02F 3/345; C02F 1/34

(57) ABSTRACT

A process for reducing the volume of a collection of acid producing mine waste material is disclosed. The process comprises: contacting a mine waste material with water under oxidative conditions to produce a mineral containing acidic water and mineral and/or sulphide depleted mine waste material; separating the mineral containing acidic water and mineral and/or sulphide depleted mine waste material; treating the mineral containing acidic water to remove one or more minerals therefrom and provide treated water; and further contacting the mine waste material and/or the mineral and/or sulphide depleted mine waste material with the treated water and carrying out the steps one or more times until a total volume of the mineral and/or sulphide depleted mine waste material is less than a total volume of the starting acid producing mine waste material. Also disclosed is a process for converting acid producing mine waste material to a more environmentally acceptable substantially non-acid producing mine waste material.

### PRIORITY DOCUMENT

The present application claims priority from Australian Provisional Patent Application No. 2016900129 titled “PROCESSES FOR TREATING ACID PRODUCING WASTE ROCK” and filed on 15 Jan. 2016, the content of which is hereby incorporated by reference in its entirety.

### INCORPORATION BY REFERENCE

The following publications are referred to in the present application and their contents are hereby incorporated by reference in their entirety:
International Patent Application No. PCT/AU2015/000538 titled “PROCESSING OF ACID MINE DRAINAGE WATER” in the name of Global Aquatica Pty Ltd;
U.S. Pat. No. 4,695,378 titled “Acid mine water aeration and treatment system” in the name of Ackman, et al.; and
U.S. Pat. No. 6,325,923 titled “Bioreactor for acid mine drainage control” in the name of Zaluski, et al.

### TECHNICAL FIELD

The present disclosure relates to methods for treating acid producing waste rock, lime sludges and tailings sludges from mining operations in order to reduce the volume of the waste rock and sludges and/or render the waste rock or sludges more environmentally compatible.

### BACKGROUND

Conventional mining practise consists of excavating mineral borne rock from the ground and extracting the desired minerals from the rock, usually by chemical processes. In the process of mining, substantial amounts of rock that does not contain sufficient minerals to warrant extraction must first be removed. This rock is called waste rock.

The substantial majority of valuable minerals on the planet are contained within sulphide rock and pyrite. Hence, waste rock from mining operations commonly consists of this type of rock. When rainwater contacts this rock it is converted into sulphuric acid by hydrolysis and oxidation as the rock is also in contact with air. The produced sulphuric acid is detrimental to the environment and needs to be contained and/or disposed of in a controlled manner.

Attempts to address the problem with acid producing waste rock have included physically relocating the massive heaps. As there are usually millions of tonnes of waste rock, this is usually too expensive and impractical to consider. Other attempts at addressing the problem include encapsulating the acid producing waste rock in an impermeable cover. The encapsulation of waste rock in non-acid producing rock or impermeable covers has usually not been successful in permanently preventing the entry of water and is extremely expensive. For example, plastic sheeting has been used to cover waste rock heaps but termites and other animals tend to create holes in the plastic and trees puncture the plastic sheet with their roots.

As the sulphuric acid forms in waste rock heaps by hydrolysis and oxidation it dissolves minerals and salts from the rock into the water. Methods such as lime chemical addition and reverse osmosis are then used to separate the contaminants from the water. The separated contaminants from lime addition form acidic sludges of calcium sulphate and metal oxides. Reverse osmosis produces sludges consisting of sulphate salts called brine. These sludges are permanently stored on the site as they dry over many decades.

After the minerals in the aforementioned rock have been removed, the remaining finely ground rock is stored as an acidic tailings sludge in a pond at which point the water in the sludge is substantially removed. These sludges are permanently stored on the site as they dry over many decades.

There is a need to provide a solution to any one or more of the above mentioned problems associated with acid producing waste rock and tailing sludges.

### SUMMARY

The present disclosure results from the inventor's efforts to substantially reduce the volume of acid producing waste rock on a site by applying water to the top of a heap of crushed waste rock; allowing the water to leach through the heap of crushed waste rock whilst permitting natural oxidation; collecting the resulting acid in a collection pond at the base of the waste rock heap; removing the minerals and acidity from the water; and recycling the treated water back onto the pile of crushed waste rock.

The method can also be applied to acid forming tailings sludge. Thus, the acid produced by the above mentioned processes can be applied to the top of a heap of lime or brine sludge; the acid allowed to leach through the heap of sludge; and the resulting mineral bound acid can be collected in a collection pond at the base of the heap; the minerals and acidity can be removed from the acid; and the treated water recycled back onto the pile of crushed waste rock and/or acid forming tailings.

In a first aspect the present disclosure provides a process for reducing the volume of a collection of acid producing mine waste material, the process comprising:
a) contacting the mine waste material with water under oxidative conditions to produce a mineral containing acidic water and mineral and/or sulphide depleted mine waste material;
b) separating the mineral containing acidic water and mineral and/or sulphide depleted mine waste material;
c) treating the mineral containing acidic water to remove one or more minerals therefrom and provide treated water; and
d) further contacting the mine waste material and/or the mineral and/or sulphide depleted mine waste material with the treated water and carrying out steps b) and c) one or more times until a total volume of the mineral and/or sulphide depleted mine waste material is less than a total volume of the starting acid producing mine waste material.

In a second aspect, the present disclosure provides a process for converting acid producing mine waste material to a more environmentally acceptable substantially non-acid producing mine waste material, the process comprising:
a) contacting the mine waste material with water under oxidative conditions to produce a mineral containing acidic water and mineral and/or sulphide depleted mine waste material;
b) separating the mineral containing acidic water and mineral and/or sulphide depleted mine waste material;
c) treating the mineral containing acidic water to remove one or more minerals therefrom and provide treated water; and
d) further contacting the mine waste material and/or the mineral and/or sulphide depleted mine waste material with the treated water and carrying out steps b) and c) one or more times until the mine waste material is converted to environmentally acceptable substantially non-acid producing mine waste material.

In certain embodiments of the first and second aspect, the acid producing mine waste material is selected from the group consisting of: acid producing waste rock and acid producing tailings.

Thus, in a third aspect the present disclosure provides a process for reducing the volume of a collection of acid producing waste rock, the process comprising:
a) contacting the waste rock with water under oxidative conditions to produce a mineral containing acidic water and mineral and/or sulphide depleted waste rock;
b) separating the mineral containing acidic water and mineral and/or sulphide depleted waste rock;
c) treating the mineral containing acidic water to remove one or more minerals therefrom and provide treated water; and
d) further contacting the waste rock and/or the mineral and/or sulphide depleted waste rock with the treated water and carrying out steps b) and c) one or more times until a total volume of the mineral and/or sulphide depleted waste rock is less than a total volume of the starting acid producing waste rock.

In a fourth aspect, the present disclosure provides a process for converting acid producing waste rock to a more environmentally acceptable substantially non-acid producing waste rock, the process comprising:
a) contacting the waste rock with water under oxidative conditions to produce a mineral containing acidic water and mineral and/or sulphide depleted waste rock;
b) separating the mineral containing acidic water and mineral and/or sulphide depleted waste rock;
c) treating the mineral containing acidic water to remove one or more minerals therefrom and provide treated water; and
d) further contacting the waste rock and/or the mineral and/or sulphide depleted waste rock with the treated water and carrying out steps b) and c) one or more times until the waste rock is converted to environmentally acceptable substantially non-acid producing waste rock.

In a fifth aspect the present disclosure provides a process for reducing the volume of a collection of acid producing tailings, the process comprising:
a) contacting the tailings with water under oxidative conditions to produce a mineral containing acidic water and mineral and/or sulphide depleted tailings;
b) separating the mineral containing acidic water and mineral and/or sulphide depleted tailings;
c) treating the mineral containing acidic water to remove one or more minerals therefrom and provide treated water; and
d) further contacting the tailings and/or the mineral and/or sulphide depleted tailings with the treated water and carrying out steps b) and c) one or more times until a total volume of the mineral and/or sulphide depleted tailings is less than a total volume of the starting acid producing tailings.

In a sixth aspect, the present disclosure provides a process for converting acid producing tailings to a more environmentally acceptable substantially non-acid producing tailings, the process comprising:
a) contacting the tailings with water under oxidative conditions to produce a mineral containing acidic water and mineral and/or sulphide depleted tailings;
b) separating the mineral containing acidic water and mineral and/or sulphide depleted tailings;
c) treating the mineral containing acidic water to remove one or more minerals therefrom and provide treated water; and
d) further contacting the tailings and/or the mineral and/or sulphide depleted tailings with the treated water and carrying out steps b) and c) one or more times until the tailings is converted to environmentally acceptable substantially non-acid producing tailings.

In a seventh aspect, the present disclosure provides a process for reducing the volume of treatment waste material obtained from the treatment of acid mine drainage water by neutralisation and hydrolysis processes using the addition of alkali materials and/or salt removal processes, the process comprising:
a) contacting acid producing treatment waste material, such as acid producing waste rock or acid producing tailings, with water under oxidative conditions to produce a mineral containing acidic water and mineral and/or sulphide depleted treatment waste material;
b) contacting the treatment waste material with the mineral containing acidic water to produce an enriched mineral containing acidic water;
c) treating the enriched mineral containing acidic water to remove one or more minerals therefrom and provide treated water; and
d) further contacting the treatment waste material and/or the mineral and/or sulphide depleted treatment waste material with the treated water and carrying out steps a) to c) one or more times until a total volume of the sulphide depleted treatment waste material is less than a total volume of the starting treatment waste material.

In certain embodiments, in the process of either the second aspect or the third aspect step a) is preceded by a step of comminuting a volume of acid producing waste rock to increase the surface area of the waste rock.

In certain embodiments, in the process of any one of the first to sixth aspects the acid producing waste rock and/or acid producing tailings are formed into a heap and water applied to the top of the heap.

In certain embodiments, in the process of the seventh aspect the treatment waste material is formed into a heap and water and acidic water applied to the top of the heap.

The step of treating the mineral containing acidic water to remove one or more minerals therefrom and provide treated water may be carried out using any of the known methods for treating acid mine drainage (AMD) water. For example, U.S. Pat. No. 4,695,378 discloses a method for treating AMD water that could be used. The treatment of heavy metal and sulfate containing AMD water in a bioreactor with sulfate reducing bacteria to produce heavy metal sulfides and reduce the sulfuric acid content of the solution is disclosed in U.S. Pat. No. 6,325,923 and that method could also be used. International patent application PCT/AU2015/000538 describes a method of removing acidity and minerals from acidic waste water.

In embodiments of the processes described herein, water that has been treated using the methods described in U.S. Pat. No. 4,695,378, U.S. Pat. No. 6,325,923, international patent application PCT/AU2015/000538 or any other suitable method is applied onto the top of the heap of waste rock or tailings, causing it to become sulphuric acid in combination with the air as the water passes through the rock or tailings, as occurs naturally. The sulphuric acid leaches the minerals from the rock or tailings into the acidic water. This mineral containing acidic water is then processed, thereby removing the minerals. The recovered minerals can be converted into valuable recyclable products. The sulphuric acid is converted into high quality water with small concentrations of minerals and no organics. This treated water is then re-applied to the top of the heap.

Using conventional hydraulic drainage techniques, the mineral containing acidic water (i.e. the pregnant liquor) may be collected in a sump pond.

Also provided herein is a mineral and/or sulphide depleted mine waste material obtained by the process of the first aspect, environmentally acceptable substantially non-acid producing mine waste material obtained from the process of the second aspect, mineral and/or sulphide depleted waste rock obtained from the process of the third aspect, environmentally acceptable substantially non-acid producing waste rock obtained from the process of the fourth aspect, mineral and/or sulphide depleted tailings obtained from the process of the fifth aspect, environmentally acceptable substantially non-acid producing tailings obtained from the process of the sixth aspect, and a sulphide depleted treatment waste material obtained by the process of the seventh aspect.

### BRIEF DESCRIPTION OF DRAWING

Embodiments of the present invention will be discussed with reference to the accompanying drawing wherein:

FIG. 1 is a flow diagram showing the steps of an embodiment of the processes described herein.

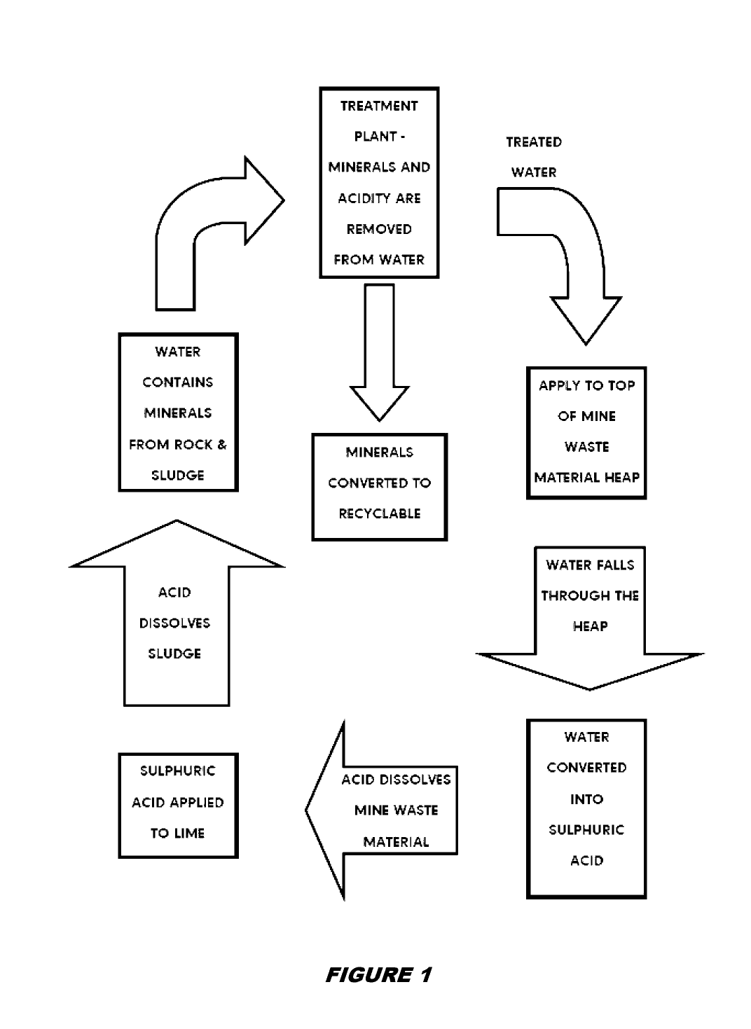

### DESCRIPTION OF EMBODIMENTS

As discussed, the present disclosure provides a process for reducing the volume of acid producing waste rock and/or tailings. These materials are collectively referred to as “acid producing mine waste material”. The present disclosure also provides a process for reducing the volume of material obtained from the treatment of acid mine drainage water by neutralisation and hydrolysis processes using the addition of alkali materials and/or salt removal processes. These materials are collectively referred to herein as “treatment waste material”.

The process of the present disclosure comprises contacting waste rock and/or tailings with water under oxidative conditions to produce a mineral containing acidic water and mineral and/or sulphide depleted waste rock and/or tailings. The mineral containing acidic water and mineral and/or sulphide depleted waste rock and/or tailings are then separated and the mineral containing acidic water is contacted with the waste product from water treatment to further increase the minerals contained in the water. The mineral containing acidic water is treated to remove one or more minerals therefrom and provide treated water. The waste rock and/or the mineral and/or sulphide depleted waste rock is then further contacted with the treated water and the waste product further contacted with the acidic water and the separation and treatment steps are repeated one or more times until the total volume of the mineral and/or sulphide depleted waste rock and/or tailings and/or waste product from water treatment is less than the total volume of the starting acid producing waste rock, acid producing tailings, and/or water treatment waste product. The process can be used to convert acid producing waste rock and/or tailings to a more environmentally acceptable substantially non-acid producing waste rock.

Water can be applied to the waste rock and/or tailings using any suitable method provided the acid producing waste rock is in contact with oxygen. For example, water can be applied to a heap of waste rock and/or tailings. In other examples, the waste rock and/or tailings can be contacted with water in a vessel, such as a rotating drum or a tank where the water level is periodically increased and reduced. In the embodiments described below, the acid producing waste rock is formed into a heap and water applied to the top of the heap by heap leach techniques conventionally used for oxide rock.

The acid producing waste rock may be comminuted to increase the surface area of the waste rock before it is contacted with the water. The step of comminuting the acid producing waste rock increases the surface area of a given rock volume in contact with a given volume of water. However, it will be appreciated that the waste rock does not necessarily need to be comminuted for the processes described herein to be effective, although comminuting the waste rock does increase the load of minerals in the mineral containing acidic water, thereby reducing treatment costs. The acid producing waste rock may be comminuted using conventional rock crushing equipment.

The acid producing waste rock is typically 100 min to 300 mm in diameter and is typically formed on site as a heap, commonly 30 metres high. The present inventors have found by experimentation that a heap of the same rock of the same height of rock that has been comminuted to sizes less than, for example, 15 mm will substantially increase the load of dissolved minerals in the water after it has travelled through the heap.

The water may be applied to the heap by any means that ensures distribution to the entirety of the rock. For example, sprinklers or ground drip systems may be used.

The present inventor has also found it is important that the flow rate of water through the heap does not exceed the flow rate at which capillary action stops, otherwise the resulting flooding will prevent oxidation of the rock. The present inventor has also found it is best to comminute the rock to a uniform size to maximise the size of the voids between the particles of crushed rock. This maximises the availability of air to the chemical reaction. As the chemical reaction is endothermic, the high void ratio combined with the constant application of water prevents combustion in the case of waste rock from coal mines.

The practise of heaping crushed mineralised rock is common, referred to as heap leach. It is commonly used to contact introduced chemicals, including sulphuric acid to cause the oxidised rock to liberate minerals into the liquid. The processes described herein differ from known acid leaching processes in that water without chemicals is applied to the top of the heap. The natural hydrolysis and oxidation caused by contact of the water with the acid producing rock converts the water into sulphuric acid. This acid then leaches the minerals from the rock in conventional heap leach fashion. Using water instead of chemicals is substantially cheaper and safer.

When the water contacts the acid producing waste rock and/or tailings (i.e. sulphide rock and pyrite (FeS₂)) it is converted into sulphuric acid by hydrolysis and oxidation as the rock is also in contact with air. Acid is produced by the oxidation of the sulfide to sulphate (reaction A), and by the oxidation and hydrolysis of iron (reaction B):

FeS₂+3.5O₂+H₂O fi Fe²⁺+2SO₄²⁻+2H⁻ (A)

Fe²⁺+2.5H₂O+0.25O₂ fi Fe(OH)₃(s)+2H⁻ (B).

Iron-oxidising bacteria accelerate pyrite oxidation by two mechanisms: direct oxidation, and oxidation of Fe²⁺ to Fe³⁺, which in turn oxidises the sulfide minerals. As the pH decreases, abiotic oxidation of Fe²⁺ slows down dramatically, according to the rate law:

$$\frac{- d ( {Fe}^{2 +} )}{dt} = \frac{k ( {O}_{2} ( aq ) ) ( {Fe}^{2 +} )}{{( {H}^{+} )}_{2}} \qquad ( C )$$

where (Fe²⁺), (O₂ (aq)), and (H⁺) are activities, k is the rate constant, and t is time. Below approximately pH 4, the iron-oxidising bacteria assume the primary role of oxidising Fe²⁺, thereby allowing reaction B to continue producing acid and ferric hydroxide. Although the reaction stoichiometry remains the same, this is a transition point from the primarily abiotic stage to the partially biological stage. The pH decline typically continues to a stage where the reaction chemistry changes to a biologically-mediated cycle of reactions D and E:

Fe⁺+0.25O₂+H⁺ fi 0.5Fc³⁺+0.5H₂O (D)

FeS₂+14Fe³⁺+8H₂O fi 15Fe²⁺+2SO₄²⁻+16H⁻ (E).

As acidification proceeds and the pH in the immediate vicinity of the pyrite falls to less than 3, the increased solubility of iron, and the decreased rate of Fe(OH)₃ precipitation results in increased Fe³⁺ activity. This is significant because as Fe³⁺ aggressively attacks pyrite, it is reduced to Fe²⁺ (reaction E) for subsequent reoxidation by iron oxidising bacteria. Oxidation of pyrite by Fe³⁺ is about an order of magnitude faster than oxidation by equivalent concentrations of dissolved oxygen, apparently because of different reaction mechanisms at the molecular level. When the pH in the immediate microenvironment of the pyrite falls to approximately 2.5 (often corresponding to a drainage pH of 3.5 to 4.0), bacterial oxidation of Fe²⁺ and reduction of Fe³⁺ by the pyrite (reactions D and E) combine to cause a dramatic increase in acidity and iron concentrations.

As this solution moves through the waste rock or tailings, it undergoes secondary reactions that raise pH, decrease concentrations of iron, and increase the concentrations of other cations. Contact with clays and other aluminosilicates releases aluminium, sodium, potassium, and magnesium, while contact with carbonate minerals releases calcium, magnesium, manganese, and additional iron (siderite). The various effects these reactions have on the chemistry of the water depend on the volume of water, the amount of pyrite oxidised, and the extent and variety of secondary chemical reactions. High sulphate levels also frequently occur, caused by some secondary reactions. The water that has been in contact with the waste rock is acidic and contains high concentrations of dissolved iron, aluminium, and manganese and other metals, such as zinc, nickel, and cobalt.

Acidity can exist as organic acidity associated with dissolved organic compounds, carbon dioxide acidity associated with dissolved carbon dioxide and carbonic acid; proton acidity associated with pH (a measure of free H⁺ ions); and mineral acidity associated with dissolved metals. The majority of acidity in the mineral containing acidic water usually arises from free protons (manifested in low pH) and the mineral acidity arising from dissolved iron, aluminium, and manganese. These metals are considered acidic because they can undergo hydrolysis reactions that produce H⁺.

Fe²⁺+0.25O₂+1.5H₂O fi FeOOH+2H⁺ (F)

Fe³⁺+2H₂O fi FeOOH+3H⁺ (G)

Al³⁺+3H₂O fi Al(OH)₃+3H⁺(H)

Mn²⁺+0.25O₂+1.5H₂O fi MnOOH+2H⁺ (I).

The mineral containing acidic water falls through the heap of comminuted acid producing waste rock, dissolving the rock as it travels to the base of the heap. A drain may be positioned at the base of the heap. For example, a layer of slotted plastic pipes may be positioned at the base of the heap. This permits the free flow of the pregnant liquor from the heap. The resulting liquor may flow by gravity into a sump, as is practised in conventional heap leach techniques.

In some embodiments, the mineral containing acidic water is pumped into a treatment plant where it is treated according to a process described by PCT/AU2015/000538. Briefly, the treatment plant comprises:
an aeration station for aerating the mineral containing acidic water, the aeration station comprising a spray unit configured to direct the mineral containing acidic water into a reservoir, the spray unit comprising a venturi aerator to oxidise the mineral containing acidic water and provide oxidised water; and
a sulphate reduction station downstream of the reservoir for reducing sulphates present in the oxidised water, the sulphate reduction station comprising a first bioreactor containing sulphate reducing bacteria.

The process described by PCT/AU2015/000538 comprises:
oxidising the mineral containing acidic water by cavitation to form oxidised water; and
reducing sulphates from the oxidised water using sulphate reducing bacteria.

Further details and embodiments of the treatment plant are described in PCT/AU2015/000538.

The treatment plant and process removes the acidity and the minerals from the water, producing high value recyclable products such as calcium carbonate, magnesium hydroxide, elemental sulphur and metal oxides. The volume of minerals extracted from the mineral containing acidic water varies with the mineralogy of the crushed rock.

The treatment plant and process also converts the acidic water back into high quality water. The present inventor's testing has shown the water is typically drinking quality with high bacterial counts. For example, the treated water would be safe to drink if it were disinfected using conventional techniques.

The high quality treated water is recycled back onto the crushed acid forming waste rock heap or onto acid forming tailings.

An advantage of using treated water is that it is free of particles. The conventional application methods of the water onto the heap involve using systems with small apertures such as drip line or sprinklers. These commonly block with suspended solids when used in conventional heap leach processes.

The entire process described in PCT/AU2015/000538 does not need to be used to treat the water. For example, advanced oxidation only may be used to remove the minerals as metal oxides. The high sulphate content treated water could then be applied to the waste rock. The sulphates will accumulate and will eventually require removal from the water. The process described in PCT/AU2015/000538 may not remove chlorides from the water. Therefore it may be necessary to incorporate an additional treatment stage to remove the chlorides from the treated water where chlorides are obtained by the leaching process. The process described in PCT/AU2015/000538 can produce water containing carbonates. These have been found to eventually encase the rock particles, preventing hydrolysis and oxidation, hence the process described in PCT/AU2015/000538 could be altered to produce water containing hydroxides which would aid in the leaching of the rock by the water.

The treated water from the process described in PCT/AU2015/000538 contains bacteria. It has been found that the sulphide oxidising bacteria in the treated water increase the rate of mineralisation of the water in the heap by a factor of 500%, particularly when ferric iron is introduced with the bacteria.

The present inventor's experiments have shown the resulting rock after leaching is substantially reduced in volume with reductions to 15% of original volume. The actual volume reduction achieved depends on the percentage of the waste rock that is acid producing. For example, most pyrite is dissolved, but a substantially less percentage of sulphide rock is dissolved. Regardless of the final rock volume, a substantial proportion of the remaining rock is rendered non-acid producing by the leaching process. Thus, the resultant rock is a more environmentally acceptable non-acid producing waste rock and tailings. This characteristic holds great value to regulators as it presents a method of eradicating acid producing rock and tailings from sites around the world. It has been estimated by regulators that there are approximately 18,000 acid producing sites in Australia and 300,000 in the USA, and substantially more in Europe.

In an example of the processes described herein, the acid producing waste rock may contain gold. Gold usually exists with the rock attached to the pyrite. The processes described herein have the effect of dissolving the pyrite rock to which the gold is attached and the gold is liberated from the rock. As gold is not soluble in sulphuric acid, it travels down the heap with the flow of water and collects at the base of the heap. From time to time the velocity of the water applied to the heap may be increased by increasing the flow rate. This has the effect of washing the gold free from the heap for collection. This gold requires no additional treatment. This process can be used to replace cyanide treatment of gold bearing ores as a very low cost, chemical free process.

Also in the example of the processes described herein, the acid producing waste rock or tailings may contain clay. Clay is dissolved by the cations present in produced acidic water with the aluminium dissolving into the water. Clay is typically aluminium silicate. The silica has a limited solubility in sulphuric acid and therefore it travels down the heap with the flow of water and collects at the base of the heap. From time to time the velocity of the water applied to the heap may be increased by increasing the flow rate. This has the effect of washing the silica free from the heap for collection. This silica requires no additional treatment. This process can be used to replace chemical treatment of silica bearing ores as a very low cost, chemical free process.

Also in the example of the processes described herein, the acid produced by contact of the water with waste rock or tailings is applied to the top of a heap of treatment waste material, such as sludge. The sludge consists of waste products from the neutralisation and hydrolysis of acid mine drainage water using alkali chemicals or a sulphate salt sludge resulting from the membrane filtration of acid mine drainage water. The sludge typically consists of calcium sulphate and metal hydroxides. The sulphuric acid from the waste rock or tailings is applied to the top of the heap of sludge and permitted to fall through the sludge. The chemical components of the sludge are dissolved into the acid with the resulting ‘pregnant liquor’ collecting in a pond. This liquor is treated to remove the minerals from the water, and the treated water is applied to a waste rock or tailings heap to reform into sulphuric acid. Testing has shown up to 100% of the sludge is removed by this method. The minerals are converted into valuable recyclable products.

### Example

Pyrite rock was crushed to 5 mm common particle size. The rock was piled into a heap of uniform height approximately 3 metres high. Ground level drip irrigation lines were used to distribute treated water onto the top of the heap at a uniform flow rate. As these heaps are in the environment they are prone to winds, hence sprinklers are not preferred. The suspended solids in the water were removed as part of the water treatment process so blocking of the lines was not a problem.

The water flows down through the heap which has a high void ratio due to the uniform particle size. The water flow rate did not exceed that of capillary action of the water through the heap thereby maximising both hydrolysis and oxidation. The temperature of the water increased as it travels through the heap which has been found to substantially enhance the biological reactions at 30 to 35 degrees C. This water temperature also enhances the advanced oxidation and bacterial reactions of the process described in PCT/AU2015/000538.

A series of slotted PVC pipes were installed beneath the rock heap. The mineral containing acidic water (pregnant liquor) flowed into the pipes, flowing by gravity into a common pond. The acidic water was pumped onto the top of a heap of sludge from lime water treatment waste and uniformly distributed over uniform height heap. The sludge dissolved into the acid on contact as it fell through the sludge and then flowed into a collecting pond. The mineral containing acidic water from the pond was pumped to a treatment plant where it was treated according to the process described in PCT/AU2015/000538 wherein metal sulphates were removed as a moist mixed metal oxide cake and the acidity also removed resulting in a circa-neutral pH.

The water was then exposed to sulphate reducing bacteria where the cations were converted from sulphates into carbonates. The sulphates were converted into elemental sulphur. Calcium carbonate precipitated from the resulting water. Advanced oxidation was then used to convert the carbonate water into hydroxides, resulting in the magnesium precipitating as magnesium hydroxides.

The resulting treated water contained a low concentration of sodium hydroxide which was recycled back onto the top of the heap using drip lines. It was found throughout that water losses did not exceed 3% provided care was taken to minimise evaporation.

The chemistry of the pregnant liquor was found to be as follows:

| | | Treated | Mineral | Natural |
|---|---|---|---|---|
| | | water | containing | acidic |
| | | applied to | acidic | waste water |
| Solute | Unit | the heap | water | from the rock |
| Elect cond | uS/cm | 431 | 43500 | 7250 |
| Sulphates | mg/L | 0 | 30435 | 5075 |
| Chlorides | mg/L | 260 | 1610 | 262 |
| Calcium | mg/L | 13 | 2885 | 479 |
| Magnesium | mg/L | 7 | 2844 | 465 |
| Sodium | mg/L | 579 | 3714 | 623 |
| Potassium | mg/L | 17 | 114 | 19 |
| Aluminium | mg/L | 0 | 476 | 78 |
| Copper | mg/L | 0 | 915 | 143 |
| Cobalt | mg/L | 0 | 8.2 | 1.4 |
| Nickel | mg/L | 0 | 15.7 | 2.2 |
| Manganese | mg/L | 0 | 228 | 34 |
| Zinc | mg/L | 0 | 52 | 9 |
| Iron | mg/L | 0 | 3913 | 652 |

The following recyclable products could be recovered from the water: calcium carbonate, magnesium hydroxide, elemental sulphur, sodium hydroxide, aluminium hydroxide, copper oxide, cobalt oxide, nickel oxide, manganese oxide, gold, zinc oxide, silica and ferric iron oxide. Gold and silica was carried by the water into the sump, but not dissolved.

It will be appreciated by those skilled in the art that the invention is not restricted in its use to the particular application described. Neither is the present invention restricted in its preferred embodiment with regard to the particular elements and/or features described or depicted herein. It will be appreciated that the invention is not limited to the embodiment or embodiments disclosed, but is capable of numerous rearrangements, modifications and substitutions without departing from the scope of the invention as set forth and defined by the following claims.

Throughout the specification and the claims that follow, unless the context requires otherwise, the words “comprise” and “include” and variations such as “comprising” and “including” will be understood to imply the inclusion of a stated integer or group of integers, but not the exclusion of any other integer or group of integers.

The reference to any prior art in this specification is not, and should not be taken as, an acknowledgement of any form of suggestion that such prior art forms part of the common general knowledge.

1. A process for reducing the volume of a collection of acid producing mine waste material, the process comprising:
a) contacting the mine waste material with water under oxidative conditions to produce a mineral containing acidic water and mineral and/or sulphide depleted mine waste material;
b) separating the mineral containing acidic water and mineral and/or sulphide depleted mine waste material;
c) treating the mineral containing acidic water to remove one or more minerals therefrom and provide treated water; and
d) further contacting the mine waste material and/or the mineral and/or sulphide depleted mine waste material with the treated water and carrying out steps b) and c) one or more times until a total volume of the mineral and/or sulphide depleted mine waste material is less than a total volume of the starting acid producing mine waste material.

2. The process of claim 1, wherein step a) is preceded by a step of comminuting the volume of acid producing mine waste material to increase the surface area of the mine waste material.

3. The process of claim 2, wherein the acid producing mine waste material is formed into a heap and water applied to the top of the heap.

4. The process of claim 1, wherein the step of treating the mineral containing acidic water to remove one or more minerals therefrom and provide treated water comprises:
oxidising the mineral containing acidic water by cavitation to form oxidised water; and
reducing sulphates from the oxidised water using sulphate reducing bacteria.

5. The process of claim 1, wherein the acid producing mine waste material is selected from the group consisting of: acid producing waste rock and acid producing tailings.

6. A mineral and/or sulphide depleted mine waste material obtained by the process of claim 1.

7. A process for converting acid producing mine waste material to a more environmentally acceptable substantially non-acid producing mine waste material, the process comprising:
a) contacting the mine waste material with water under oxidative conditions to produce a mineral containing acidic water and mineral and/or sulphide depleted mine waste material;
b) separating the mineral containing acidic water and mineral and/or sulphide depleted mine waste material;
c) treating the mineral containing acidic water to remove one or more minerals therefrom and provide treated water; and
d) further contacting the mine waste material and/or the mineral and/or sulphide depleted mine waste material with the treated water and carrying out steps b) and c) one or more times until the mine waste material is converted to environmentally acceptable substantially non-acid producing mine waste material.

8. The process of claim 7, wherein step a) is preceded by a step of comminuting the volume of acid producing mine waste material to increase the surface area of the mine waste material.

9. The process of claim 8, wherein the acid producing mine waste material is formed into a heap and water applied to the top of the heap.

10. The process of claim 7, wherein the step of treating the mineral containing acidic water to remove one or more minerals therefrom and provide treated water comprises:
oxidising the mineral containing acidic water by cavitation to form oxidised water; and
reducing sulphates from the oxidised water using sulphate reducing bacteria.

11. The process of claim 7, wherein the acid producing mine waste material is selected from the group consisting of: acid producing waste rock and acid producing tailings.

12. Environmentally acceptable substantially non-acid producing mine waste material obtained from the process of claim 7.

13. A process for reducing the volume of treatment waste material obtained from the treatment of acid mine drainage water by neutralisation and hydrolysis processes using the addition of alkali materials and/or salt removal processes, the process comprising:
a) contacting acid producing treatment waste material, such as acid producing waste rock or acid producing tailings, with water under oxidative conditions to produce a mineral containing acidic water and mineral and/or sulphide depleted treatment waste material;
b) contacting the treatment waste material with the mineral containing acidic water to produce an enriched mineral containing acidic water;
c) treating the enriched mineral containing acidic water to remove one or more minerals therefrom and provide treated water; and
d) further contacting the treatment waste material and/or the mineral and/or sulphide depleted treatment waste material with the treated water and carrying out steps a) to c) one or more times until a total volume of the sulphide depleted treatment waste material is less than a total volume of the starting treatment waste material.

14. The process of claim 13, wherein the treatment waste material is formed into a heap and water and acidic water applied to the top of the heap.

15. A sulphide depleted treatment waste material obtained by the process of claim 13.
